(19) United States
(12) Patent Application Publication
(10) Pub. No.: US 2002/0129335 A1
(43) Pub. Date: Sep. 12, 2002

(54) Robust logging system for embedded systems for software compilers

(75) Inventor: Jody Western Lewis, Farmington, UT (US)

Correspondence Address: Jack E. Haken, Corporate Patent Counsel, U.S. Philips Corporation, 580 White Plains Road, Tarrytown, NY, 10591, US

(73) Assignee: PHILIPS ELECTRONICS NORTH AMERICA CORP.

(21) Appl. No.: 09/739,517

(22) Filed: Dec. 18, 2000

(51) Int. Cl. G06F 9/45; G06F 9/44

(52) U.S. Cl. 717/124

(57) ABSTRACT

A pre-processing script parses a message catalog of logging statements. Each record, for example, may include a distinct log message, a format string, and place-holders for variables plus a description. The script then generates a header file which defines each type of message contained in the message catalog. It then defines macros for each type of message. When a programmer writes code, he/she uses the macro format rather than the standard language format. The macros resolve upon compilation to a call to a function respective of the type and number of arguments required for the particular instance of the generic logging call. When the code is finally compiled, the compiler will generate error messages when the number and type of arguments do not match.

### BACKGROUND OF THE INVENTION

1. Field of the Invention

The invention relates to mechanisms for defining logging operations in computer software and more specifically to such mechanisms for logging statements requiring a fixed number and/or type of arguments, the mechanisms being such as to cause the checking of the number and type of arguments at compile time.

2. Background

Logging is a generic term used to describe all manner of auditing events occurring in an on-going software process. A familiar example is the tracking of steps when connecting via a modem to a computer. As each step in the connection is completed, the logging system outputs a message to the connecting terminal. If an error occurs, it is immediately possible to determine how far the process went before the error halted it. Generally logging results in the generation of text messages, which can optionally be stored in a compact token form until read later when the tokens are replaced by readable text.

Software is often written so that the same code can be used for users in different localities speaking different languages. Instead of embedding the alternative logging statements in the executable software itself, a message catalog is used to store the alternative language formats. The software will be written to produce only codes or canonical forms of logging statements which may then be converted using the catalog. The conversion may occur when the log output is read (assuming the canonical output is temporarily stored) or it may be converted immediately after generation of the canonical form and output on an output or storage device.

In some systems, the statements used to generate logging output may take arguments that are fixed in number and generic in type. For example, the statement could take a format string, and a fixed length series of arguments of any of a variety of types such as integer, string, floating point value, etc. Such statements may be specific to the operating system or part of the program language. If the arguments are fixed in number, for example, not all may be used. If the arguments can be any type, even though the particular format statement is not compatible with them, it is difficult to ensure that these calls have been accurately programmed. This is because during compilation, the arguments are not checked for type and/or number appropriate for the particular logging event defined. The only alternative is to test the logging statements by executing, but this is laborious and often impracticable. Finally, run-time testing does not provide a convenient indication of where the logging error occurred. Newer object-oriented (OO) languages provide one type of solution, but in some systems, for example embedded systems, software authors may be restricted to non-OO languages for at least some portions of their code.

### SUMMARY OF THE INVENTION

The invention solves the foregoing problems incident to the prior art by providing a pre-processing script that relies on a message catalog, not for languages, but for the various types of logging statements. The message catalog contains message structures, each defined in a record. Each record, for example, may include a distinct logging message, a format string, and place-holders for variables plus a description. The latter would be appropriate where the compiler's logging statement took the form of a generic statement, followed by a format statement and a fixed number of arguments.

The invention uses the message catalog with a pre-processing script which parses the message catalog to determine the number of arguments required for each record. The script then generates a header file which defines a macro for each type of message defined in the message catalog. When a programmer writes code, he/she uses the macro format rather than the standard language format. The macros resolve upon compilation to a call to a function that contains a call in the standard language format. However, the function is specific to the type and/or number of arguments required by the particular message. When the code is finally compiled, the pre-processor has replaced all the macros with function calls respective of the number and/or type of arguments. Thus, in this case, the compiler will generate error messages when the number and/or type of arguments do not match.

The invention will be described in connection with certain preferred embodiments, with reference to the following illustrative figures so that it may be more fully understood. With reference to the figures, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

### BRIEF DESCRIPTION OF THE DRAWING

FIG. 1 is a flow chart of process for checking for logging call errors according to an embodiment of the invention.

FIG. 2 is a block diagram representing the prior art method of forming logging call.

FIG. 3 is a block diagram of a method of forming a logging call according to an embodiment of the invention.

FIG. 4 is a block diagram illustrating a method of forming a logging call according to an embodiment of the invention using automated generation of macros to provide diagnostic information that may be revealed at compile time.

### DETAILED DESCRIPTION OF THE PREFERRED EMBODIMENTS

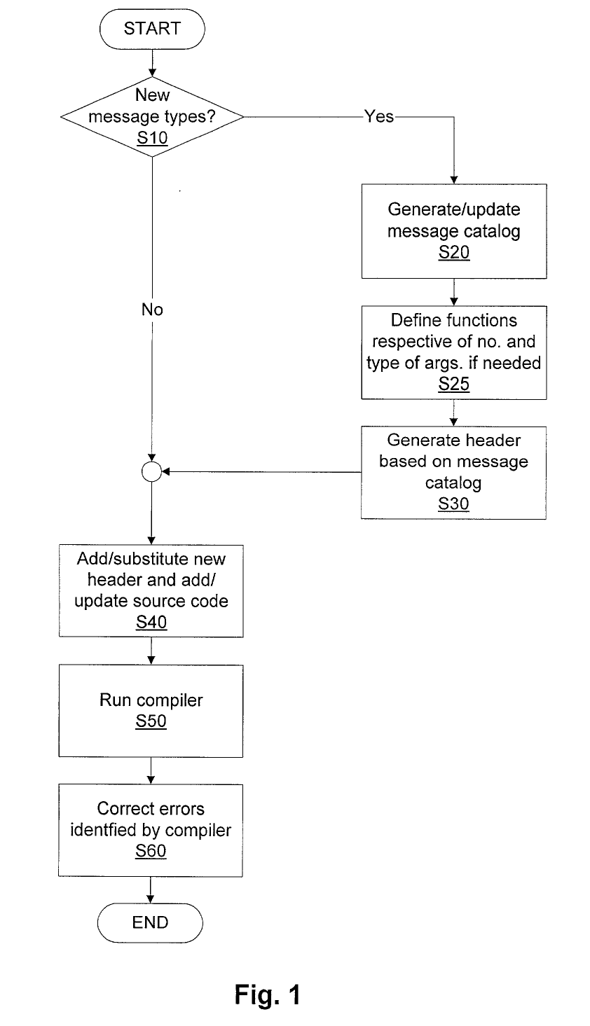

Referring to FIG. 1, a programmer regularly writes new source code, or updates old source code, by adding calls that generate new logging output. In the event that such logging calls are of a type not previously contained in the old code, or in the event that a new program is being drafted, new message types exist (S10) and a new or updated message catalog is generated in step S20. The message catalog is a list of logging message types. In an embodiment of the invention, the message catalog has the format shown in the table below.

| | | | | | | | |
|---|---|---|---|---|---|---|---|
| Rec. | Name | Format | F1 | F2 | F3 . . . | Fn | Descr. |

Functions taking a number and/or type of argument(s) required for each type of message are defined in step S25. These functions may be generic to a class of logging message types. For example, there may be a respective function for messages requiring 1 argument, another for messages requiring 2 arguments, etc. Alternatively, there may be a separate function for each combination of number and type of argument.

In step S30, the message catalog is parsed and header is generated that creates macro definitions for each type of logging message (i.e., one for each record) in the message catalog. Each macro is defined to call the appropriate function. The resulting new header file is added to a new source code file or substituted for an old one in step S40 and any new source code that is based on the new message types is added to the source code. The compiler is then run in step S50 and any errors resulting from a mismatch of argument number or type reviewed and appropriate corrective action taken in step S60.

An example of a header in a portion of a C file is as follows.

| / * Log message indexes */ | |
|---|---|
| #define LoggingVersion | 0×0001 |
| #define VideoSyncLost | 0×0002 |
| #define OutputLocked | 0×0004 |

/* Log call macros */
#define LOG_LoggingVersion(v0) (vlog1Event(LoggingVersion,
(v0) ) )
#define LOG_VideoSyncLost() (vlog0Event(VideoSyncLost) )
#define LOG_OutputLocked(v0, v1, v2)
(vlog3Event(OutputLocked, (v0), (v1), (v2) ) )

The programmer can then use the log call macros in his/her code. For example, the following statement may appear.

LOG_OutputLocked(2, 0, 1)

which is replaced during compilation by

(vlog3Event(0×0004, (2),(0),(1)))

Thus, when the compiler encounters one of these statements during a pre-compilation step, it substitutes the macro text with a function call as defined in the log call macro definitions. In other words, every incidence of LOG_LoggingVersion(XYZ) will be changed to vlog1Event(0×NNNN, XYZ), where “0×NNNN” is the message number of the particular logging event and “XYZ” is the argument used in the macro statement.

Note that an important element here is that in the log call macro definitions, a different function is used depending on the number of arguments. The functions actually perform the steps required to generate the logging output. Each function contains an appropriate logging statement, but within the function definition, as in the prior art, the statement(s) is (are) identical in terms of the number and type of argument. By passing the arguments through a function respective to the number and type of arguments required, the respective function being tied to the type of log event required in the macro definitions, the compiler is enabled to check the number and type of arguments in the macro statements during compilation. This results in an indication of exactly where the improper syntax occurred before run time.

The following is an example listing of a function definition. The following code defines a logging function that takes four arguments.

vlog4Event(int msgNumber, int v0, int v1, int v2)
{

logMsg(format[msgNumber], (int)v0, (int)v1, (int)v2,

0, 0, 0) ;

}

In the above code sequence, “format” is an array of message formats, “msgNumber” is an index into the format array, and “logMsg” is a standard system logging call which takes a fixed number of arguments (7) of a fixed type (the first being a string and the remaining six being integers).

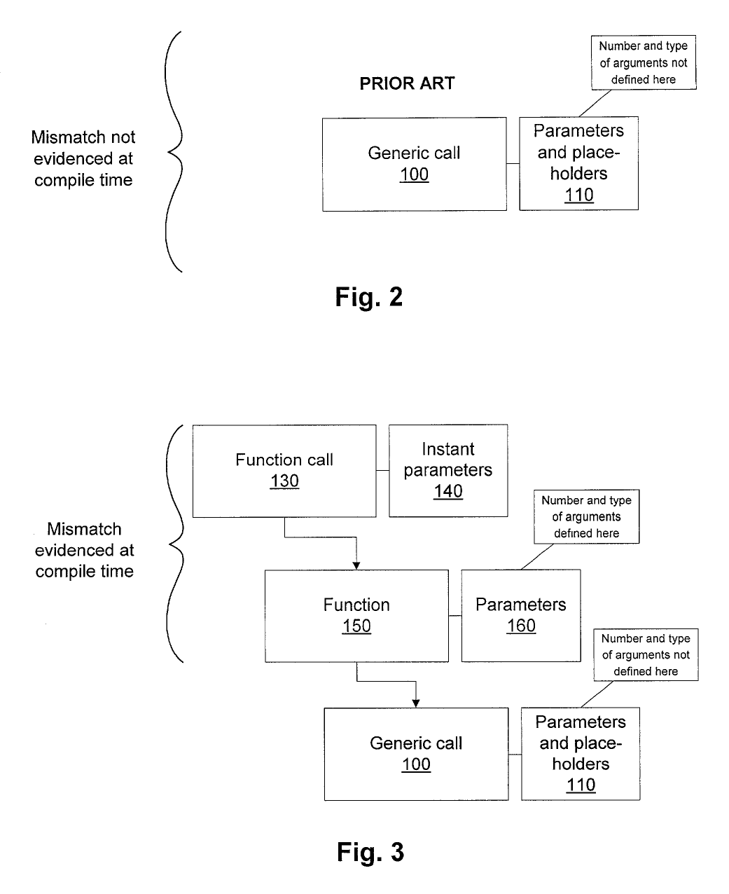

Referring now to FIGS. 2 and 3, to compare the prior art and present strategy for generating logging output, the prior art strategy is illustrated in FIG. 2 and the present strategy in FIG. 3. In the prior art method, a generic call 100 is available by way of the usual mechanisms: a function library, as an operating system device, or a statement generic to the programming language. The generic call 100 has a number of parameters and whether one is used or not depends on other parameters used in an instance of the statement. In the inventive method, the generic call 100 is accessed indirectly through a function 150 which is defined to have a number and/or respective types of arguments specific to a particular class of logging operation (such as placing logging data on a queue). The function definition contains the appropriate generic syntax and routes the arguments of the function appropriately to the arguments of the generic call 100. The function call 130 with its appropriate set of parameters 140 is used in the programmer's code to generate appropriate logging events as the program executes. As a result of the interceding function, the number and/or type of arguments can be checked at compile time rather than at run time.

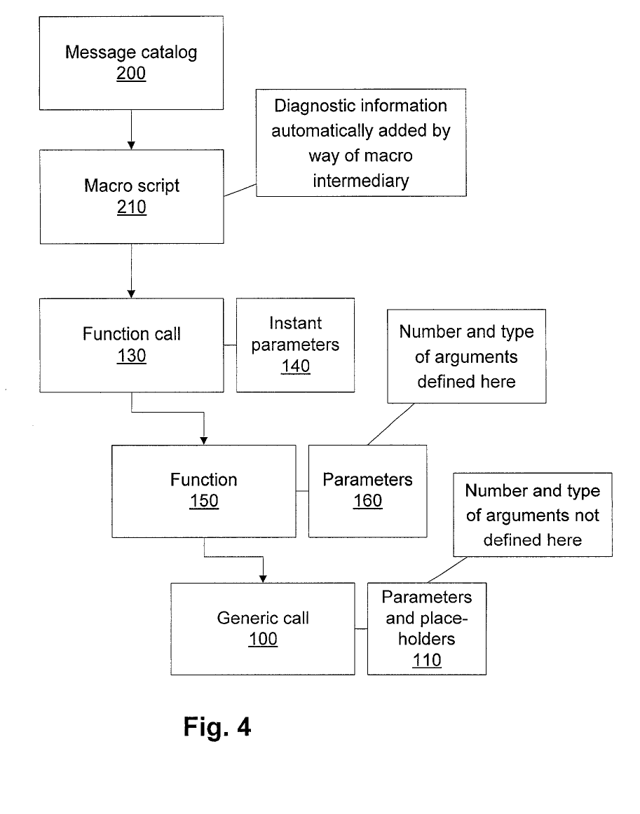

Referring to FIG. 4, by routing function calls through macros and automating the macro definition process, the logging message system can providing otherwise tedious diagnostic devices that can be used for error checking. For example, the file name and line number may be conditionally attached to the log messages. (Note, when the compile command is issued compiler options can be specified. Typically one of the compiler options is to compile for development or for production release. This is the condition “conditionally” refers to. In other words, two sets of macro definitions are generated. One set contains the additional diagnostic information—file and line number—and the other one does not. These two sets of macro definitions are then surrounded by a precompiler conditional directive—if/then/else. If the code is compiled for development the set with additional information is used. If the code is compiled for production release the other set is used, since the additional information is of no interest to the customer.) This may be accomplished by having the pre-processor script attach a pre-compiler directive for the filename and line number to the macro definition (e.g., #define LOG₁₃ LoggingVersion(v0) (vlog3Event(LoggingVersion, v0, _LINE_, _FILE_))) This can be done without the programmer's assistance and turned on for development and off for production. Thus, the message catalog 200 is parsed by a macro script 210 to generate the macro definitions that include the diagnostic information.

It will be evident to those skilled in the art that the invention is not limited to the details of the foregoing illustrative embodiments, and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A method of programming an operation, comprising the steps of:
defining a function containing a statement ultimately executing a logging operation;
said function containing at least one argument of at least one of a number and type specific to a particular logging operation;
said statement being generic to arguments of at least one of a number and type;
calling said function in a program, whereby a mismatch between said at least one of a number and type specific to said particular logging operation may be revealed by compiling said program.

2. A software medium as in claim 1, wherein said operation is a logging operation.

3. A software medium with a program containing the following:
a function definition with a statement ultimately executing, at run time, a logging operation;
said function containing at least one argument of at least one of a number and type specific to a particular logging operation;
said statement being generic to arguments of at least one of a number and type;
said program calling said function, whereby a mismatch between said at least one of a number and type specific to said particular logging operation may be revealed by compiling said program.

4. A software medium as in claim 3, wherein said operation is a logging operation.

5. A method of programming a logging script, comprising the steps of:
defining functions respective of a number and/or type of arguments, said arguments being passed to a program statement requiring at least said arguments;
generating a logging message catalog containing classes of logging messages;
defining macros translating programming statements into respective ones of said functions responsively to said message catalog;
referring to said macros in a program.

6. A method as in claim 5, wherein said step of defining macros include defining macros that conditionally attach a file name and/or line number to a respective log message.
